(19) United States
(12) Patent Application Publication
(10) Pub. No.: US 2016/0126826 A1
(43) Pub. Date: May 5, 2016

(54) CIRCUIT AND METHOD FOR BALANCING SUPERCAPACITORS IN A SERIES STACK USING MOSFETS

(71) Applicant: ROBERT CHAO, SUNNYVALE, CA (US)

(72) Inventor: ROBERT CHAO, SUNNYVALE, CA (US)

(21) Appl. No.: 14/530,544

(22) Filed: Oct. 31, 2014

(51) Int. Cl. H02M 1/32

(52) U.S. Cl. CPC H02M 1/32

(57) ABSTRACT

A circuit for automatically balancing leakage current has at least two supercapacitors coupled in series. A respective MOSFET is placed across each of the at least two supercapacitors.

### TECHNICAL FIELD

The present application generally relates to supercapacitors, and, more particularly, to a circuit and method for balancing supercapacitors in a series stack using MOSFETs to minimize over-voltage issues.

### BACKGROUND

Supercapacitors are becoming increasingly useful in high-voltage applications as energy storage devices. When an application requires more voltage than a single 2.7 volt cell can provide, supercapacitors are stacked in series of two or more. An essential part of ensuring long operational life for these stacks is to balance each cell to prevent leakage current from causing damage to other cells through over-voltage.

Applications for these supercapacitor stacks are rapidly growing, but the problem of leakage current and over-voltage is not well known. However, since supercapacitor stacks in high-voltage energy storage applications represent the next-generation, designers need a clear path forward to address this significant problem.

Therefore, it would be desirable to provide a circuit and method that overcome the above problems. The circuit and method will be able to provide over-voltage protection to supercapacitor stacks. The circuit and method will be able to provide leakage current equalization to provide over-voltage protection to supercapacitor stacks.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a circuit for balancing leakage current has at least two supercapacitors coupled in series. A respective MOSFET is placed across each of the at least two supercapacitors.

In accordance with another aspect of the present application, a circuit for balancing leakage current of supercapacitors has a first supercapacitor coupled to a voltage source. A second supercapacitor is coupled to the first supercapacitor in series and to ground potential. A first MOSFET is attached across the first supercapacitor. A second MOSFET is attached across the second supercapacitor.

In accordance with yet another aspect of the present application, a method for balancing supercapacitors coupled in series comprises: testing a first supercapacitor for a first supercapacitor maximum rated leakage current; testing a second supercapacitor for a second supercapacitor maximum rated leakage current; attaching the first supercapacitor in series to the second supercapacitor; selecting a first MOSFET having a first MOSFET threshold voltage, the first MOSFET turns off or on exponentially based upon the first MOSFET threshold voltage to limit a maximum voltage level across the first supercapacitor to a leakage current level of the second supercapacitor when a leakage current of the second supercapacitor is higher than a leakage current of the first supercapacitor; selecting a second MOSFET having a second MOSFET threshold voltage, the second MOSFET turns off or on exponentially based upon the second MOSFET threshold voltage to limit a maximum voltage level across the first supercapacitor to a leakage current level of the first supercapacitor when a leakage current of the first supercapacitor is higher than a leakage current of the second supercapacitor; attaching the first MOSFET across the first supercapacitor; and attaching the second MOSFET across the second supercapacitor.

### BRIEF DESCRIPTION OF DRAWINGS

Embodiments of the disclosure will become more fully understood from the detailed description and the accompanying drawings, wherein:

FIG. 1 is a simplified schematic of a pair of supercapacitors coupled in series;

FIG. 2 is a simplified schematic in accordance with one aspect of the present application of a circuit for limiting leakage current in supercapacitors coupled in series;

FIG. 3 is a simplified schematic of the circuit of FIG. 2 when a leakage current of a second supercapacitor C2 is larger than a leakage current in a first supercapacitor C1;

FIG. 4 is a simplified schematic of the circuit of FIG. 2 when the leakage current of the first supercapacitor C1 is larger than the leakage current in the second supercapacitor C2; and

FIG. 5 is a simplified schematic of the circuit of FIG. 2 when the first second supercapacitor C1 and the second supercapacitor C2 are approximately balanced.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

By diagramming two supercapacitors in series and showing how MOSFETs may manage the cells implemented in a series stack, a designer may be able to gain insight on how to control leakage current of each cell and thus prolong the life of each supercapacitor.

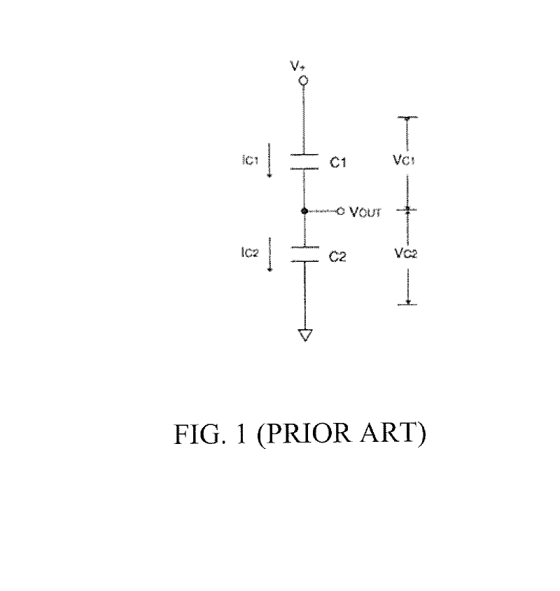

Referring to FIG. 1, a pair of supercapacitors C1 and C2 may be seen connected in series. In accordance with one embodiment, the capacitive value of supercapacitor C1 may be approximately equal to the capacitive value of supercapacitor C2. While this not a requirement that the capacitive value of supercapacitor C1 be approximately equal to the capacitive value of supercapacitor C2, this a design choice of many designers. It should be noted, that while the capacitive value of supercapacitor C1 may be approximately equal to the capacitive value of supercapacitor C2, they are never exactly the same in real world applications. All the cells differ slightly and each one may have different capacitance values as well as different leakage currents levels.

A supercapacitor manufacturer generally does not provide the exact leakage current specification required to balance the supercapacitor. The datasheet typically provides maximum leakage current, but the actual leakage can vary significantly, even for parts manufactured from the same lot and with the same part number. Additionally, over time, the temperature and leakage current values will change depending upon the actual material composition and construction of each supercapacitor.

The capacitive value of supercapacitor C1 may be approximately equal to the capacitive value of supercapacitor C2. In this embodiment, there are three potential scenarios. In Scenario 1, C1 exhibits a leakage current value noted here as I_{C1} and C2 has leakage current of I_{C2}. If the two leakage currents I_{C1} and I_{C2} are exactly the same, ironically, the supercapacitors C1 and C2 would be balanced. For example, if the power supply V+ is 4.6V, if I_{C1}=I_{C2}, then V_{OUT}=V+/2=2.30V. Thus, each supercapacitor C1 and C2 may have a 2.7V max. rating.

However, in Scenario 2, if I_{C2}>I_{C1}, V_{OUT} drops until the leakage current balances I_{C1}=I_{C2}. If V_{C1}=(V+−V_{OUT})>2.7V, then supercapacitor C1 will eventually fail due to over-voltage.

In Scenario 3, if the leakage current of I_{C1} is greater than I_{C2} (I_{C1}>I_{C2}), then V_{OUT} rises until the leakage current balances I_{C1}=I_{C2}. If V_{OUT}=V_{C2}>2.7V, supercapacitor C2 may be damaged and may eventually fail because the voltage across it would exceed 2.7V (i.e. over-voltage).

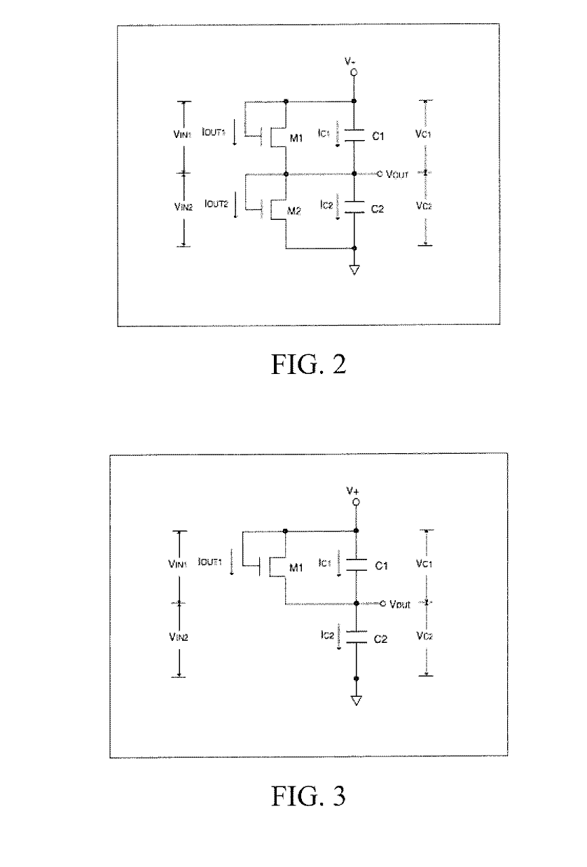

Referring now to FIG. 2, a switching device 12 may be placed across the pair of supercapacitors C1 and C2 may be seen connected in series. The switching device 12 may be a pair of MOSFETs M1 and M2 placed across the two supercapacitors C1 and C2. The MOSFETs M1 and M2 may be used to balance the supercapacitors C1 and C2. Any type of MOSFET may be used for supercapacitor balancing. However, only certain MOSFETs with specific characteristics may work in practice. The balancing operation depends upon the relationship between the supercapacitor operating voltage, supercapacitor leakage currents and the threshold voltage of the MOSFETs M1 and M2 as will be described below.

MOSFET M1 may be connected across the supercapacitor C1, so input V_{IN1} of the MOSFET M1 may be equal to supercapacitor voltage V_{C1}. MOSFET M2 may be connected across supercapacitor C2, so V_{IN2} of the MOSFET M2 may be equal to supercapacitor voltage V_{C2}.

There is leakage current going through each one of the MOSFETs M1 and M2, referred to as I_{OUT1} for MOSFET M1 and I_{OUT2} for MOSFET M2.

A simple circuit analysis of the circuit of FIG. 2 shows that V+ is equal to V_{IN1}+V_{IN2}=V_{C1}+V_{C2}. In other words, the two voltages across the MOSFETs M1 and M2 may be equal to the two voltages across both supercapacitors C1 and C2. The total leakage current now becomes I_{C1}+I_{OUT1}=I_{C2}+I_{OUT2}

Referring now to FIG. 3, operation of how the MOSFETS M1 and M2 operate will be described. If the leakage current I_{C2} of the supercapacitor C2 is greater than the leakage current I_{C1} of the supercapacitor C1, then the voltage V_{OUT} may drop a little bit until the MOSFET M1 is turned on. When the MOSFET M1 is turned on, the other MOSFET M2 is turned off.

This changes the equation: I_{OUT1} of MOSFET M1+the leakage current I_{C1} of the supercapacitor C1 is equal to I_{C2} (I_{OUT1}+I_{C1}=I_{C2}). The other MOSFET M2 disappears because it is turned off exponentially, so I_{OUT2}=0. V_{OUT} voltage can keep dropping until I_{OUT1} equals the difference between IC1 and IC2. Without I_{OUT1}, V_{OUT} can go down to 0.0 volt. That would kill the supercapacitor C1 in the series as the voltage across it exceeds 2.7V

The unsaid condition is that the supercapacitor output voltage V_{OUT}, which is a mid-point voltage between the supercapacitors, can go as far as 0.0V or 4.6V. If it does, it will slowly destroy one and then the next supercapacitor in the series.

In this case, if supercapacitor C2 is leaking more current than supercapacitor C1, the output voltage V_{OUT} is going to keep going down. But as the output voltage keeps dropping, the voltage across the supercapacitor C1 increases until the supercapacitor C1 succumbs to over-voltage and fails.

If supercapacitor C2 is leaking despite a clamp down on voltage, then it will force more voltage across the supercapacitor C1 until it bursts. When supercapacitor C1 bursts, it can cause a short circuit and sent 4.6V across supercapacitor C2, and eventually the cell will also fail. When supercapacitor C1 bursts, it can also result in an open circuit and render the supercapacitor network to be inoperative.

The MOSFETs M1 and M2 can prevent this. It senses that the voltage wants to go down, so MOSFET M1 starts leaking current very quickly, without allowing the voltage to go down much. Because it is exponential in nature and the current goes up, it will automatically float to a point where the current I_{OUT1}, plus the I_{C1} current would be equal to the leakage current of C2, which is I_{C2}.

There is a push-pull dynamic relationship. In other words, there are two supercapacitors C1 and C2 and two MOSFETs M1 and M2, but only one MOSFET is turned on at any given time. Since there is no way to know which supercapacitor C1 or C2 has higher leakage, placing the MOSFETs across both supercapacitors C1 and C2 will balance the network automatically.

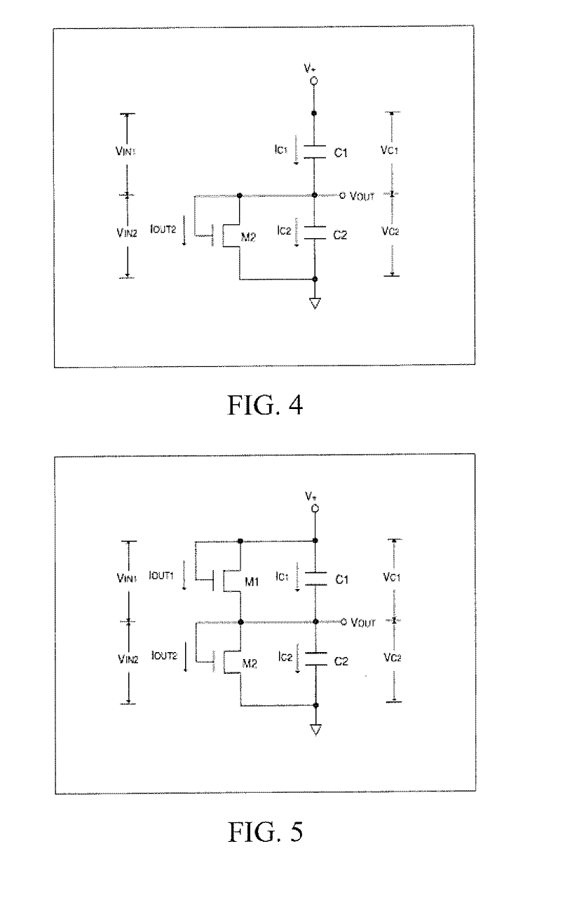

In FIG. 4, supercapacitor C1 has a higher leakage, so the top MOSFET M1 may be actually turned off. This the case where the top MOSFET “disappears” as only one of them is actually conducting at any time. The active MOSFET would be M2, but it would balance C1 with greater leakage.

Since the specific leakage of each supercapacitor is unknown, when there are two supercapacitors, the one that has the higher leakage would be automatically balanced by the MOSFET. When a MOSFET is placed across a supercapacitor, it automatically balances the system, by equalizing whichever supercapacitor has the highest leakage current.

The MOSFET is able to turn itself off but both MOSFETs do not turn off simultaneously. Only one of them will turn off. In the case shown in FIG. 4, MOSFET M1 would turn itself off completely.

When the MOSFET turns itself off; the total leakage current is only equal to the higher of I_{C1} or I_{C2}, whichever supercapacitor that has the highest leakage current in the stack.

Balancing with MOSFETs is automatic, simple and elegant to implement. When connected across the supercapacitors, one MOSFET will turn itself on automatically to balance and the other one will turn itself off automatically to balance the stack. Depending on which way it goes, the balancing scheme is fully automated, hence “auto-balancing”. This auto-balancing scheme is scalable and stackable, extending to any number of supercapacitors connected in series without limitations on the number of cells the design requires. Another way to view the mechanism is that each MOSFET automatically senses the voltage across it and turns itself off or turns itself on exponentially, based upon its rated design threshold voltage.

There is no way to tell which supercapacitor in a series has higher leakage current before they are linked together. It is also difficult to determine the exact leakage current in any supercapacitor, because time, environment and application can introduce unforeseen variables. It is, however, possible to test each supercapacitor for a maximum rated leakage current before being connected to a series stack.

MOSFET balancing adds only a negligible amount of leakage, compared to the maximum rated supercapacitor leakage current. Balancing without adding leakage current is not possible with an op-amp solution or other passive resistor balancing solution. A quiescent current may be required to power up the op-amp. It forces the voltage to a higher leakage point of the supercapacitor because it will only balance to the midpoint voltage.

The MOSFET solution while adding little or no leakage, does allow a lower voltage bias on the leakier supercapacitor, so that the actual total leakage of the series-connected supercapacitors can be potentially less than not balancing the circuit at all. As an example, if one supercapacitor is leaking 10 times that of the other one, the difference between the two supercapacitor voltages would be a total of 100 mV, its voltage could be off by as much as 50 mV from the mid-point. The other 50 mV would be added to the less leaky supercapacitor. The leakier supercapacitor would see a lower voltage bias than the mid-point, which is a favorable condition. The leakier the supercapacitor, the lower its voltage, which in turn lowers its leakage current. The other supercapacitor, however, would experience an increased voltage across it, but limited by the SAB MOSFET to the max voltage at the leakage current level of the leakier supercapacitor.

But if the leakage current difference between supercapacitors is much less than 10 times, then the voltage difference could be off by less than 100 mV, or less than 50 mV from the mid-point, as balancing is actually dependent upon adding just enough leakage current to balance the leakier of the supercapacitors in a series stack. The other MOSFET exponentially turns itself off to the extent that the leakage current becomes inconsequential.

Referring now to FIG. 5, a third scenario is presented, where both supercapacitors C1 and C2 are exactly balanced, which implies that they are exactly equal in leakage current However, in reality one leakage current is usually greater than the other. Even when only a small amount of leakage difference occurs the cells will still eventually fail although it may take several weeks or even months, postponing the inevitable. Without active balancing with MOSFETs there is no mechanism to reverse the over-voltage excursions.

In balancing the third scenario, both MOSFETs M1 and M2 are slightly turned on. The values of the MOSFETs M1 and M2 need to be picked so that they will not burn power. Most of the time, when one MOSFET is turned on, the other MOSFET is turned off, as mentioned earlier. The exact amount of current they consume is a lot less than the leakage current of either supercapacitor C1 or C2. Supercapacitor leakage current will vary tremendously depending upon the leakage currents of each individual cell.

The second MOSFET will turn off and go “incognito,” but if you use it in a different stack of supercapacitors, there is no way to know which one is turning on because the individual leakage current situation is unknown. The voltages measured across the supercapacitors would confirm that auto-balancing is working.

The MOSFETs automatically balance supercapacitors. The MOSFETs lower additional leakage currents to near zero levels. The MOSFETs are scalable and stackable to any number of supercapacitors. The MOSFETs automate the balancing process and adjusts for changing environmental conditions and leakage currents.

Selecting the right MOSFET may require knowledge of the supercapacitor operating voltage and maximum rated leakage current. This method limits leakage current better than any other method. MOSFETs are stackable and scalable whether you use two or 100 supercapacitors in series.

MOSFETs actively adjust to different temperature or supercapacitor chemistry changes. They adjust automatically, no change to the circuitry is needed. A designer can just pick the maximum operating voltage margin and the maximum leakage current for the particular supercapacitor(s) and look up the correct MOSFET.

While embodiments of the disclosure have been described in terms of various specific embodiments, those skilled in the art will recognize that the embodiments of the disclosure may be practiced with modifications within the spirit and scope of the claims.

What is claimed is:

1. A circuit for balancing leakage current comprising:
at least two supercapacitors coupled in series;
a respective MOSFET placed across each of the at least two supercapacitors.

2. The circuit of claim 1, wherein each respective MOSFET limits a maximum voltage level across a corresponding supercapacitor of the at least two supercapacitors to a leakage current level of a leakier supercapacitor of the at least two supercapacitors.

3. The circuit of claim 1, wherein each of the at least two supercapacitors are approximately of a same capacitive value.

4. The circuit of claim 1, wherein each MOSFET automatically senses a voltage level across said each MOSFET turns off or on exponentially, based upon a rated design threshold voltage of each of said MOSFET.

5. A circuit for balancing leakage current of supercapacitors comprising:
a first supercapacitor coupled to a voltage source;
a second supercapacitor coupled to the first supercapacitor in series and to ground potential;
a first MOSFET attached across the first supercapacitor; and
a second MOSFET attached across the second supercapacitor.

6. The circuit of claim 5, wherein the first MOSFET limits a maximum voltage level across the first supercapacitor to a leakage current level of the second supercapacitor when a leakage current of the second supercapacitor is higher than a leakage current of the first supercapacitor.

7. The circuit of claim 5, wherein the second MOSFET limits a maximum voltage level across the second supercapacitor to a leakage current level of the first supercapacitor when a leakage current of the first supercapacitor is higher than a leakage current of the second supercapacitor.

8. The circuit of claim 5, wherein the first MOSFET limits a maximum voltage level across the first supercapacitor to a leakage current level of the second supercapacitor when a leakage current of the second supercapacitor is higher than a leakage current of the first supercapacitor and the second MOSFET limits a maximum voltage level across the second supercapacitor to a leakage current level of the first supercapacitor when a leakage current of the first supercapacitor is higher than a leakage current of the second supercapacitor.

9. The circuit of claim 5, wherein the second supercapacitor has a capacitive value approximately equal to a capacitive value of the first supercapacitor.

10. The circuit of claim 5, wherein the first MOSFET automatically senses a voltage level across the first MOSFET and turns off or on exponentially, based upon a rated design threshold voltage of the first MOSFET.

11. The circuit of claim 5, wherein the second MOSFET automatically senses a voltage level across the second MOSFET and turns off or on exponentially, based upon a rated design threshold voltage of the second MOSFET.

12. The circuit of claim 5, wherein the first MOSFET automatically senses a voltage level across the first MOSFET and turns off or on exponentially, based upon a rated design threshold voltage of the first MOSFET and the second MOSFET automatically senses a voltage level across the second MOSFET and turns off or on exponentially, based upon a rated design threshold voltage of the second MOSFET.

13. A method for balancing supercapacitors coupled in series comprising:
determining a maximum rated leakage current of a first supercapacitor;
determining a maximum rated leakage current of a second supercapacitor;
attaching the first supercapacitor in series to the second supercapacitor;
selecting a first MOSFET having a first MOSFET threshold voltage, the first MOSFET turns off or on exponentially based upon the first MOSFET threshold voltage to limit a maximum voltage level across the first supercapacitor to a leakage current level of the second supercapacitor when a leakage current of the second supercapacitor is higher than a leakage current of the first supercapacitor;
selecting a second MOSFET having a second MOSFET threshold voltage, the second MOSFET turns off or on exponentially based upon the second MOSFET threshold voltage to limit a maximum voltage level across the first supercapacitor to a leakage current level of the first supercapacitor when a leakage current of the first supercapacitor is higher than a leakage current of the second supercapacitor;
attaching the first MOSFET across the first supercapacitor; and
attaching the second MOSFET across the second supercapacitor.

14. The method of claim 13, selecting a capacitive value of the second supercapacitor to be approximately equal to a capacitive value of the first supercapacitor.
